(19) United States
(12) Patent Application Publication
(10) Pub. No.: US 2026/0176878 A1
(43) Pub. Date: Jun. 25, 2026

(54) ROOF ATTACHMENT CLAMP

(71) Applicant: Homecrest Roofing, Jersey Shore, PA (US)

(72) Inventors: Christopher B. STOLTZFUS, Jersey Shore, PA (US); Henry B. STOLTZFUS, Jersey Shore, PA (US); Henry B. BEILER, Jersey Shore, PA (US)

(21) Appl. No.: 18/987,860

(22) Filed: Dec. 19, 2024

(51) Int. Cl. E04D 13/10; E04D 3/36; F16B 2/06

(52) U.S. Cl. CPC E04D 13/10; E04D 3/3603; F16B 2/065

(57) ABSTRACT

A clamp for attaching articles to snap-lock style standing seam roof panels includes a U-shaped body including first and second legs. An angled hook extends from a distal end of the second leg toward the first leg. An angled opening in the first leg receives a clamping bolt which may be extended toward the second leg. The angled hook includes an edge which engages a surface of the standing seam near the upfacing roof surface as the bolt is extended into contact with the standing seam to secure the clamp to the standing seam. The U-shaped body further includes a second opening configured to receive a fastener for connecting articles to the clamp.

### FIELD OF THE INVENTION

The present disclosure is generally directed to a mount for attaching items to a metal roof and, more particularly, to an improved clamp for attaching articles to a standing seam metal roof.

### BACKGROUND OF THE INVENTION

Metal roofs can be formed by connecting multiple panels together where the edges of adjacent metal panels are interconnected in a manner that defines a roof joint or a standing seam. In some configurations, the edges are folded one or more times to form the standing seam, generally referred to as mechanical standing seams. In other configurations, edges of metal roof panels are specifically configured to interlock and secure adjacent panels, generally referred to as snap lock standing seams. Snap lock standing seam roof panels may also include provisions, such as nail flanges or clips positioned beneath the upwardly exposed portions of the panels, to allow panels to be anchored to the underlying support without piercing the upwardly exposed portions of the panels.

Mounting articles on metal roofs, such as snow guards or support brackets, can be problematic as such connections may be attached to the roof by a screw, nail, or other fastener which pierces the roofing surface. Piercing the roof can lead to undesired leakage due to inadequate sealing or shearing of the fastener by the forces exerted thereon by sliding snow and/or ice. Sealants, and/or gaskets are often applied around the holes pierced through the roofing surface; however, such measures complicate installation and may not fully prevent leaks. Alternatively, clamps which engage opposing sides of standing seams may be provided to secure articles to the roof. Such clamps may offer limited structural capacity as they rely on friction between the clamp and the standing seam. Other clamp designs pierce the surface of the standing seam material to improve structural capacity of the clamp but compromise the leak resistance of the roof system.

The need to mount articles on metal roofs is further complicated by variations in the seams that are used to join adjacent roof panels. Standing seams may employ mechanical joints. In these, edges of adjacent panels are upturned and abutted as two panels are prepared for joining. The standing edges are then folded over with a roll forming tool which crimps the panels together and secure them to each other. The edges may be folded once (single fold) or twice (double fold) for additional leak resistance using the roll forming tool. Mechanical joint standing seams are generally characterized by a base of the standing seam that is two layers of the panel sheeting in thickness with a folded portion of four or more panel thicknesses at the top. The folded portion generally encompasses half or less of the height of the standing seam. Clamps designed for use with mechanical standing seams may include a U-shaped clamped having a pair of legs. An extension is provided on one of the legs which extends toward the other leg and which is positioned in an undercut area below the folded portion of the standing seam when the clamp is installed. The extension engages the underside of the folded portion of the seam and prevents uplift disengagement) of the clamp from the standing seam.

Snap-lock standing seams include panel edges that are roll-formed to create male-female interlocking configurations which secure adjacent panels together when installed. The interlocking configurations are formed in the panels prior to panel installation on a roof. As panels are installed, the edges are brought into engagement and “snapped” into a locking position at which point the interlocking configurations inhibit separation of the joined panels. Snap-lock standing seams are characterized in that the portion of the standing seam positioned above the plane of the roof panel is primarily the formed snap-lock connection with little space between the connection and the plane of the roof panel. This design renders clamps optimized for mechanical joint standing seams ineffective as there is limited undercut area beneath the snap-lock connection in which the extension portion may be positioned.

What is needed is a clamp for mounting articles on standing seam roofs which engages the seams without piercing the panel material while providing sufficient structural strength to retain articles securely positioned on the roof. The clamp should be optimized for installation on snap lock style standing metal seams without piercing the surface of the metal.

### SUMMARY OF THE INVENTION

Accordingly, the present invention, in any of the embodiments described herein, may provide one or more of the following advantages:

In one embodiment, a clamp for attaching an article to a standing seam of a metal roof includes a-shaped body having a base with a first leg and a second leg extending therefrom to define an open space therebetween. A threaded aperture is provided in the first leg and configured to receive a bolt, the bolt having an end and being moveable to vary spacing between the end and the second leg. A hook extends from a distal end of the second leg into the open space toward the first leg, the hook having an angled profile with an edge. Moving the bolt end into the open space and into contact with a first side of the standing seam draws the edge into contact with a second side of the standing seam to secure the clamp to the standing seam.

In an embodiment, a clamp for attaching an article to a standing seam of a metal roof includes a-shaped body having a base with a first leg and a second leg extending therefrom to define an open space therebetween. A threaded aperture is provided in the first leg and configured to receive a bolt, the bolt having an end and being moveable to vary spacing between the end and the second leg. The threaded aperture is angled in relation to the first leg to angle the bolt downwardly as it extends into the open space.

In an embodiment, a clamp for attaching an article to a standing seam of a metal roof includes a-shaped body having a base with a first leg and a second leg extending therefrom to define an open space therebetween. A threaded aperture is provided in the first leg and configured to receive a bolt, the bolt having an end and being moveable to vary spacing between the end and the second leg. A hook extends from a distal end of the second leg into the open space toward the first leg, the hook having an angled profile with an edge. Moving the bolt end into the open space and into contact with a first side of the standing seam draws the edge into contact with a second side of the standing seam to secure the clamp to the standing seam. The clamp further includes a second threaded aperture in the base configured to receive a fastener and allow connection of an article to the clamp.

In an embodiment, a clamp for attaching an article to a standing seam of a metal roof includes a U-shaped body having a base with a first leg and a second leg extending therefrom to define an open space therebetween. A hook extends from a distal end of the second leg into the open space toward the first leg, the hook having an angled profile with an edge. The U-shaped body and the hook may be formed from a flat plate using a metal stamping operation.

In an embodiment, a clamp for attaching an article to a standing seam of a metal roof includes a U-shaped body having a base with a first leg and a second leg extending therefrom to define an open space therebetween. A hook extends from a distal end of the second leg into the open space toward the first leg, the hook having an angled profile with an edge.

In an embodiment, a clamp for attaching an article to a standing seam of a metal roof that is durable in construction, easily assembled, and simple and effective to use is provided.

Other features and advantages of the present invention will be apparent from the following more detailed description of the preferred embodiment, taken in conjunction with the accompanying drawings which illustrate, by way of example, the principles of the invention.

### BRIEF DESCRIPTION OF DRAWINGS

The advantages of this invention will be apparent upon consideration of the following detailed disclosure of the invention, especially when taken in conjunction with the accompanying drawings wherein:

FIG. 1 illustrates a conventional standing seam metal roof with articles attached thereto;

FIG. 2 is a cross-section view of an embodiment of a mechanical joint standing seam used on a metal roof;

FIG. 3 is a cross-section view of an embodiment of a snap-lock standing seam used on a metal roof;

FIG. 4 is a cross-section view of an embodiment of a snap-lock standing seam incorporating a panel fastener flange;

FIG. 5 is a perspective view of an embodiment of a clamp for use on a metal roof snap-lock standing seam showing attachment of an article;

FIG. 6 is end view of an embodiment of a clamp for a snap-lock standing seam;

FIG. 7 is a first view of an embodiment a clamp for a metal roof standing seam during installation on a snap-lock standing seam; and

FIG. 8 is a second view of an embodiment a clamp for a metal roof standing seam once installed on a snap-lock standing seam.

Wherever possible, the same reference numbers will be used throughout the drawings to represent the same parts. Alphanumeric references may reference specific components when used in total; general reference to components may use the numeric portion only.

### DETAILED DESCRIPTION OF THE INVENTION

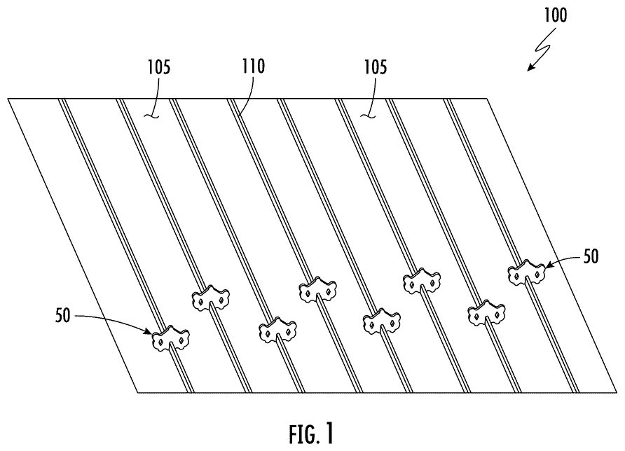

FIG. 1 illustrates a standing seam metal roof 100 having a plurality of articles, snow guards in the exemplar, that are attached to standing seams 110. The metal roof comprises a plurality of roof panels 105 that are joined together at the standing seams to create a leak-resistant surface.

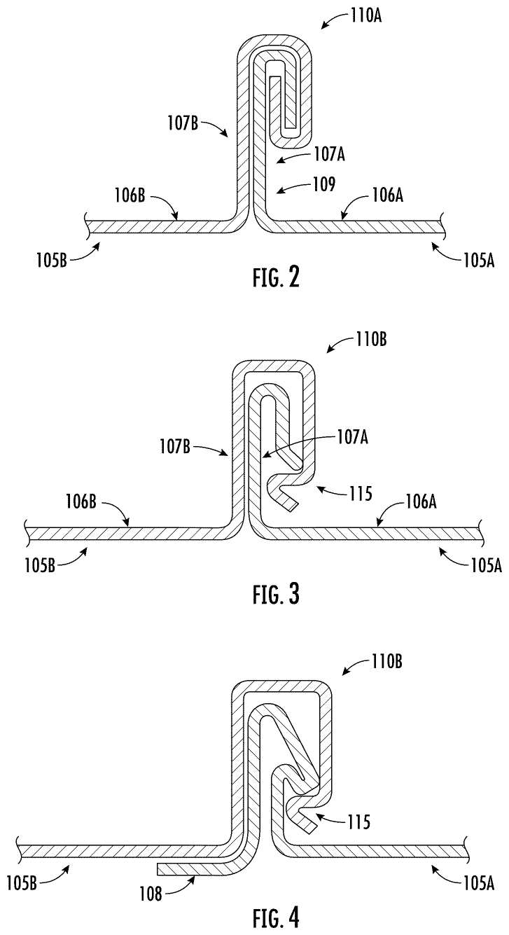

The standing seams include upturned portions 107 of each of the roof panels 105A, 105B that extend generally above the up-facing surfaces 106 of the roof panels. Adjacent panels 105A, 105B are brought together at standing seam joints which structurally connect the adjacent panels and provide a water-tight connection of the panels. The upturned ends 107 may be further shaped into one of several standing seam joint designs. Cross-sectional views of some common types of standing seams used to join metal roof panels are illustrated in FIGS. 2 through 4.

FIG. 2 illustrates a mechanical joint standing seam 110A in which upturned portion 107A, 107B of the adjacent panel ends are folded over with a tool to join the adjacent panels once the panels are positioned on the roof. The ends 107 may be folded once (single fold) or twice (double fold) for additional leak resistance using a roll forming tool. Mechanical joint standing seams are generally characterized by a base of the standing seam that is two layers of the panel sheeting in thickness with a folded portion of four or more panel thicknesses at the top. The folded portion is generally positioned well above the up-facing roof surface 106, leaving a significant portion of the upturned ends, characterized as being only two panel thicknesses, beneath the folded seam, referred to herein as the root. This design allows clamps which extend beneath the roll-formed folds to clamp the root of the seam; uplift resistance is provided by contact between the clamp and the folded mechanical joint, the folded portion comprising more panel thicknesses than the two panel thicknesses of the root of the seam.

FIG. 3 illustrates a snap-lock standing seam 110B in which upturned panel ends are roll-formed to create male-female interlocking configurations. The interlocking configurations are formed prior to panel installation. Adjacent panels in snap-lock seamed roofing systems are identified as an underlap panel 105A and an overlap panel 105B, dependent upon the relative position of the panel in the snap-lock joint between the connection and the upward-facing plane of the roof panel. As panels are installed, the roll-formed ends are brought into engagement and “snapped” into a locking position at which point the interlocking configurations inhibit separation of the panels. Snap-lock standing seams are characterized by the portion of the upturned ends uninvolved in the snap-lock structure is significantly less in comparison to roots of mechanical seams.

FIG. 4 illustrates a variation of a standing seam in which the underlap panel 105A edge includes an additional nail or fastener flange 108 to allow the underlap panel edge to be secured to the underlying roof structure. This design improves uplift resistance of the roof by connecting the panel edge to the supporting structure without compromising leak resistance; the connector flange is positioned beneath the overlap panel 105B when the joint is assembled. The standing seam 110B is similar to the conventional standing seam in that interlocking connections comprise most of the standing seam located above the roof panel up-facing surface, leaving only a small root portion.

The configuration variations in standing metal roof seams require different approaches for clamps which mechanically connect to the standing seams and allow for articles to be connected to the roof. Clamps designed for use with mechanical standing seams may include a U-shaped clamped having a pair of legs, one of which includes an extension toward the other leg which is positioned below the folded portion of the standing seam when installed. The extension engages the underside of the folded portion of the seam and prevents uplift disengagement) of the clamp from the standing seam. Because of the differing standing seam configurations clamps optimized for mechanical standing seams are unlikely to perform similarly on different standing seam types, particularly snap-lock seam which have limited clearance between the roof surface and the interlocking portions of the seam.

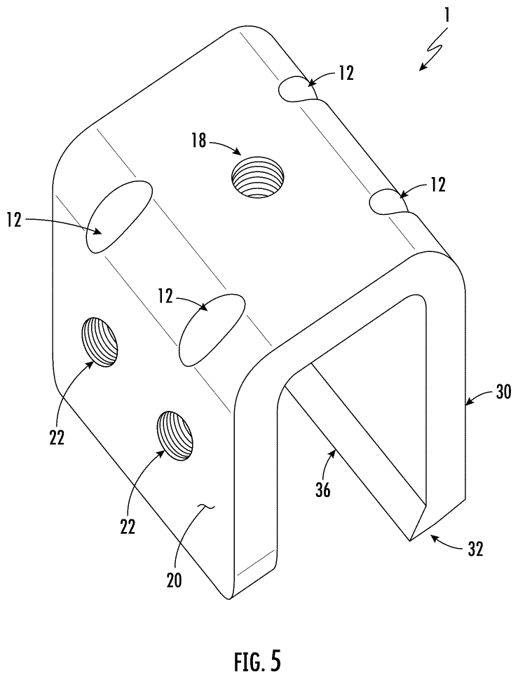

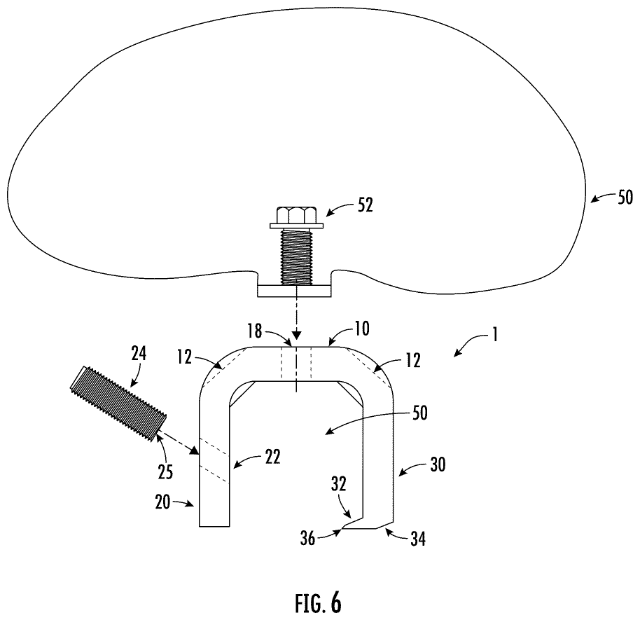

FIGS. 5 and 6 illustrate a standing seam clamp 1 used on a snap-lock style standing seam roof comprising a base 10 with a first leg 20 and a second leg 30 extending therefrom to create a generally U-shaped clamp structure. The clamp 1 is configured to be positioned atop a metal roof standing seam 110 so that the seam is positioned in the open space 50 between the legs 20, 30. The first leg 20 includes a threaded aperture 22 configured to receive a moveable bolt 24 which may be moved axially through the aperture 22 by rotation of the bolt 24 bringing an end 25 thereof into contact with the standing seam 110. Movement of the bolt alters the clamping force applied to the standing seam. The threaded aperture 22 may include multiple apertures dependent upon the length of the clamp 1. The threaded aperture 22 is preferably angled in relation to the first leg 20 so that the moveable bolt 24 angles downwardly as it enters the open space 50. The angle may be selected to optimize clamping force applied to the standing seam. The angle may be selected to optimize tool access to the moveable bolt during installation. The angle of the threaded aperture and bolt may be at least 5 degrees. The angle of the threaded aperture may be between 5 degrees and 15 degrees. The angle of the threaded aperture may be approximately 8 degrees.

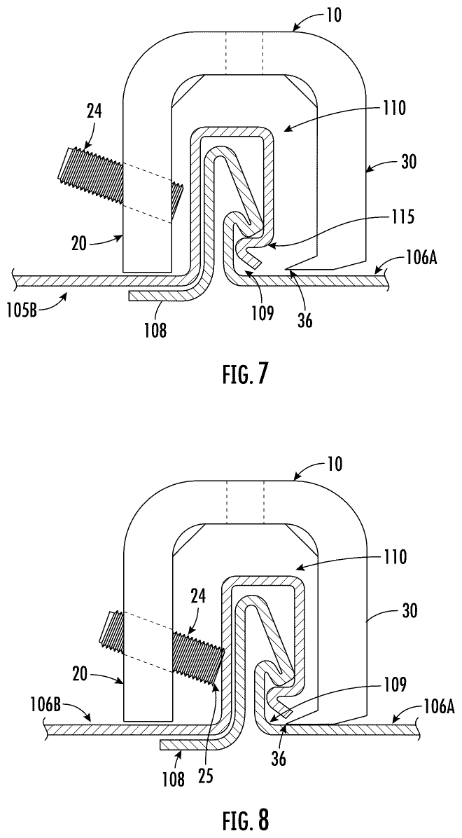

The second leg 30 includes a hook 32 extending from a distal end 34 of the second leg toward the first leg 20. The hook 32 has an angled profile which terminates in an edge 36. The edge 36 may extend along the entire length of the second leg 30. When the clamp 1 is positioned for installation on a snap-lock standing seam (FIG. 7), the edge 36 is positioned to extend beneath the snap-lock portion of the standing seam, referred to as the overlap ridge 115, in a position to engage the root 109 of the upturned end 106 of the roof panel 105 adjacent to the standing seam-roof surface intersection (root 109) to assure engagement of the edge 36 with the underlap panel 105A. The movable bolt 24 may be moved to being end 25 into contact with the overlap panel 105B generally opposite of the contact point of the edge 36 with the underlap panel 105A. Continued tightening movement of the moveable bolt 24 reduces the spacing between the end 25 and the edge 36 and applies a clamping force on the standing seam without releasing the interlock function of the snap-lock connection.

The clamp may include one or more reinforcing ribs 12 positioned at the juncture of each leg 20, 30 and the base 10. The reinforcing ribs strengthen the connection between the base and legs to reduce flexure in the clamp 1 as the moveable bolt 24 is moved to tighten the clamp 1 on the standing seam 110.

The clamp 1 may be formed from sheet or plate stock by a metal stamping operation for economic efficiency. The clamp base 10, legs 20, 30, and hook 32 are preferably formed from a unitary material blank, such as plate steel or aluminum, and shaped by one or more stamping operations into the U-shaped structure. The hook may be formed by a stamping operation on the distal end of the second leg.

Clamp 1 preferably includes a second threaded aperture 18 in the base 10 to allow an article 50 to be connected to the clamp 1 and thereby secured to a standing seam roof. The treaded aperture 18 may receive a fastener 52 to allow connection of the article 50. The article 50 may be a snow guard. The article 50 may be roof-mounted equipment such as solar panel assemblies or satellite receiver antennae.

It is important to note that the construction and arrangement of the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

1. A clamp for attaching an article to a standing seam on a metal roof comprising:
a U-shaped body having a base with a first leg and a second leg extending therefrom, the legs defining an open space therebetween;
a threaded aperture in the first leg configured to receive a bolt, the bolt having an end and being moveable to vary spacing between the end and the second leg;
a hook extending from a distal end of the second leg into the open space toward the first leg, the hook having an angled profile with an edge;
wherein the edge is drawn into contact with a second side of the standing seam positioned in the open space as the bolt end contacts an opposing first side of the standing seam and is moved toward the second leg.

2. The clamp of claim 1, wherein the threaded aperture is angled in relation to the first leg.

3. The clamp of claim 2, wherein the angle of the threaded aperture is at least 5 degrees.

4. The clamp of claim 2, wherein the angle of the threaded aperture is within the range of 5 degrees to 15 degrees.

5. The clamp of claim 2, wherein the angle of the threaded aperture is 8 degrees.

6. The clamp of claim 1, wherein the U-shaped body and the hook are formed by a metal stamping operation.

7. The clamp of claim 1, further comprising a second threaded aperture in the base configured to allow connection of an article to the clamp.

8. The clamp of claim 7, wherein the article is a selected from a list of a snow guard, a solar panel assembly, and an antennae.

9. A method for attaching an article to a standing seam on a metal roof comprising the steps of:
providing a clamp having a U-shaped body with a base, and a first leg and a second leg extending from the base and spaced apart to define an open space therebetween;
providing a threaded aperture in the first leg configured to receive a bolt, the bolt having an end;
providing a hook extending from a distal end of the second leg into the open space toward the first leg, the hook having an angled profile with an edge;
positioning the clamp on a metal roof so that a portion of the standing seam in within the open space and distal ends of the first and second legs are adjacent to an upfacing surface of the metal roof;
moving the bolt end into contact with a first side of the standing seam; and
continuing to move the bolt end to urge the hook edge into contact with the standing seam thereby securing the clamp to the standing seam.

10. The method of claim 8, wherein the first side of the standing seam is an overlap panel in the standing seam and the second side in an underlap panel in the standing seam.

11. The method of claim 9, wherein the edge contacts the underlap panel at a location between an overlap ridge on the overlap panel and the upfacing surface of the metal roof.

12. The method of claim 8. wherein the threaded aperture is angled in relation to the first leg.

13. The method of claim 11, wherein the angle of the threaded aperture is at least 5 degrees.

14. The method of claim 11, wherein the angle of the threaded aperture is within the range of 5 degrees to 15 degrees.

15. The method of claim 11, wherein the angle of the threaded aperture is 8 degrees.

16. The method of claim 8, further comprising the steps of:
providing a second threaded aperture in the base; and
fastening an article to the second threaded aperture.

17. The method of claim 15, wherein the article is a selected from a list including a snow guard, a solar panel assembly, and an antennae.
